(19) United States
(12) Patent Application Publication
(10) Pub. No.: US 2022/0215465 A1
(43) Pub. Date: Jul. 7, 2022

(54) PREDICTIVE MODELING BASED ON PATTERN RECOGNITION

(71) Applicant: Capital One Services, LLC, McLean, VA (US)

(72) Inventors: Natasha Mitchko, New York, NY (US); Max Miracolo, Brooklyn, NY (US); Abdelkader M'Hamed Benkreira, New York, NY (US)

(21) Appl. No.: 17/140,569

(22) Filed: Jan. 4, 2021

(51) Int. Cl. G06Q 40/02; G06Q 20/10; G06N 3/04; G06Q 20/24

(52) U.S. Cl. CPC G06Q 40/025; G06Q 20/24; G06N 3/0454; G06Q 20/102

(57) ABSTRACT

Aspects described herein may provide a method and system that comprises monitoring, by a transaction server, a bank account associated with a user and training a predictive model to define one or more patterns based on activity in the bank account. The method and system may further comprise authenticating an identity of the user in conjunction with a credit card purchase and then posting a purchase amount associated with the credit card purchase to a credit card account associated with the user. The method and system may also comprise predicting, based on correlating the purchase amount with the one or more patterns using the predictive model, that the purchase amount will or will not be paid in full when due and generating an option to the user to refinance the purchase amount, wherein the generating the option occurs prior to when a payment for the credit card purchase is due.

### FIELD OF USE

Aspects of the disclosure provide for systems and methods for the automated monitoring of financial account activity. More particularly, aspects of the disclosure are directed to training a predictive model to identify patterns to predict when a purchase made on credit will not be paid in full when due.

### BACKGROUND

With the growth of the internet, electronic marketplaces, and ease of online ordering, the use of electronic payment has become commonplace. Users can place an order using their credit card with a few clicks of a mouse. Tap and pay smart terminals may exist at a physical merchant's establishment which allow for a user to electronically pay for a purchase with a simple tap of a card or smart device (e.g., phone, watch, tablet, etc.). Or, a user can simply swipe their credit or debit card at a terminal for a purchase. In summary, the use of cash in transactions is decreasing while the use of electronic based instruments is increasing.

Given this trend, consumers run the risk of making a purchase where they may lack the financial resources to fully pay a credit card bill for a purchase by the due date. In such a case, the user may choose to make a partial payment to pay the balance over time and incur interest fees.

### BRIEF SUMMARY

Given the foregoing, what is needed is an automated system and method to monitor a user's bank account balance over time to train a predictive model (e.g., machine learning model) to define a pattern of activity in the user's bank account such that when a user uses a credit card to make a purchase the predictive model (e.g., machine learning model) may predict whether the user will be able to pay for the purchase in full when payment is due. If the predictive model (e.g., machine learning model) predicts that the user will not be able to pay for a purchase in full when payment is due, the user may be provided with an option to refinance the purchase amount and amortize payments over a period of time, for example, when the purchase posts to the user's account. By refinancing the purchase amount and amortizing payments over time, this may provide added value to customers by reducing their monthly payments, increasing their credit score, and/or allowing them to save more.

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects discussed herein may provide a computer-implemented method that comprises monitoring, by a transaction server, an account (e.g., bank account, credit card account, etc.) associated with a user and training a predictive model (e.g., machine learning model) to recognize one or more patterns based on activity in the account. The training may be based on the monitoring and/or through a plurality of iterations. The method may comprise authenticating, by the transaction server, an identity of the user in conjunction with a purchase (e.g., credit card purchase) and then posting, by the transaction server, a purchase amount associated with the credit card purchase to a credit card account associated with the user. The credit card account and bank account may be administered by the same transaction server. The method may also comprise predicting, based on correlating the purchase amount with the one or more patterns using the predictive model (e.g., machine learning model), that the purchase amount will not be paid in full when due and generating, based on the predicting, an option for the user to refinance the purchase amount, wherein the generating the option may occur prior to when a payment for the credit card purchase is due.

In another embodiment, an apparatus may comprise one or more processors and memory storing instructions that, when executed by the one or more processors, cause the apparatus to monitor a bank account associated with a user. The instructions may also train a predictive model (e.g., machine learning model) to define and refine a pattern of activity in the bank account through a plurality of iterations. The predictive model (e.g., machine learning model) may also authenticate an identity of the user in conjunction with a credit card purchase. The instructions may also post a purchase amount associated with the credit card purchase to a credit card account associated with the user. The credit card account and bank account may be administered under control of the apparatus. The apparatus may predict, based on the predictive model (e.g., machine learning model), that the purchase amount will not be paid in full when due. The instructions may also generate, based on the prediction, an option to the user to refinance the purchase amount. Generating the option to refinance may occur prior to the due date of the next credit card statement.

In another embodiment, a non-transitory computer readable medium may store instructions that, when executed by one or more processors, cause a computing device to perform steps including monitoring a bank account associated with a user and training a predictive model (e.g., machine learning model), based on the monitoring, to define and refine a pattern of activity in the bank account through a plurality of iterations. The steps may comprise authenticating an identity of the user in conjunction with a credit card purchase and posting a purchase amount associated with the credit card purchase to a credit card account associated with the user. In some examples, the credit card account and bank account may be administered by the same transaction server. The monitoring may comprise detecting and/or determining recurring deposits, recurring charges, an average daily spend, and/or an average daily account balance. The steps may also comprise predicting, based on the predictive model, that the purchase amount will not be paid for in full when due. Based on a determination that the purchase amount will not be paid in full, the steps may comprise generating one or more refinancing options for the purchase amount. Generating the option to refinance may occur prior to when a payment for the credit card purchase is due and, in some instances, shortly after the purchase amount is posted to the credit card account. The steps may further comprise sending the option to refinance to a mobile communication device associated with the user and receiving, from the user, an indication of an acceptance of the option to refinance, wherein the purchase amount is credited to the credit card account.

### BRIEF DESCRIPTION OF THE DRAWINGS

The present disclosure is illustrated by way of example and not limited in the accompanying figures in which like reference numerals indicate similar elements and in which:

FIG. 1 depicts an example of a computing device that may be used in implementing one or more aspects of the disclosure in accordance with one or more illustrative aspects discussed herein;

FIG. 2 depicts an example system for performing predictive modeling based on pattern recognition using machine learning;

FIG. 3 depicts an overview flow diagram of a predictive model used to analyze user financial activity in accordance with one or more illustrative aspects discussed herein; and

FIG. 4 depicts an overview flow diagram of a method to monitor bank account balances of a user to determine a pattern of activity to create a predictive model to determine eligibility for refinancing a credit purchase in accordance with one or more illustrative aspects discussed herein.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

By way of introduction, aspects discussed herein may relate to systems, methods, techniques, apparatuses, and non-transitory computer readable media automated customer verification and review using transaction data. Such methods and systems may comprise servers, such as a transaction server, that communicates with providers and users of that provider's services or goods.

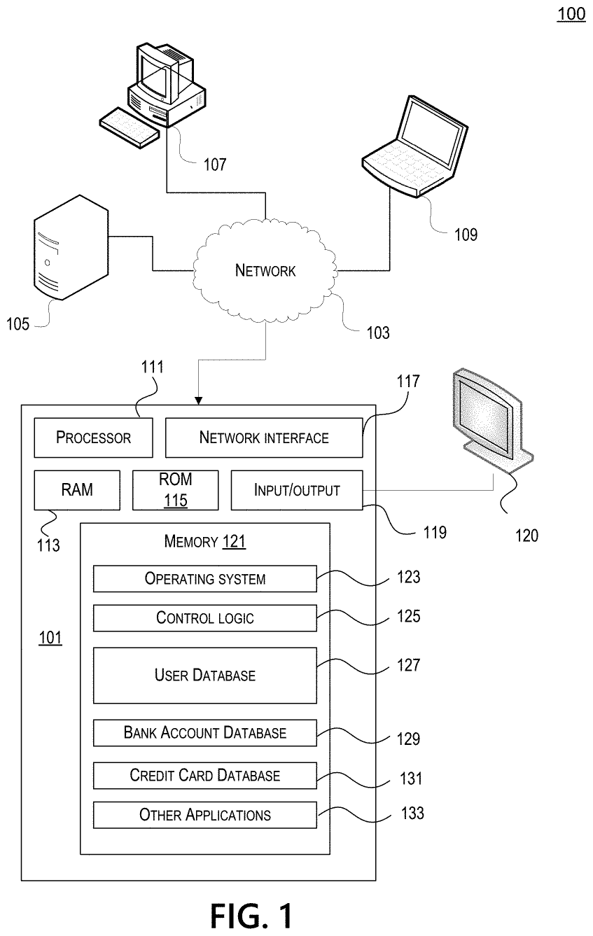

Before discussing these concepts in greater detail, however, several examples of a computing device that may be used in implementing and/or otherwise providing various aspects of the disclosure will first be discussed with respect to FIG. 1.

FIG. 1 illustrates one example of a computing device 101 that may be used to implement one or more illustrative aspects discussed herein. For example, computing device 101 may implement one or more aspects of the disclosure by reading and/or executing instructions and performing one or more actions based on the instructions. In some embodiments, computing device 101 may represent, be incorporated in, and/or include various devices such as a desktop computer, a computer server, a bank of servers, including local and remote servers, a mobile device (e.g., a laptop computer, a tablet computer, a smart phone, any other types of mobile computing devices, and the like), and/or any other type of data processing device.

Computing device 101 may, in some embodiments, operate in a standalone environment. In others, computing device 101 may operate in a networked environment. As shown in FIG. 1, various network nodes 101, 105, 107, and 109 may be interconnected via a network 103, such as the Internet. Other networks may also or alternatively be used, including private intranets, corporate networks, LANs, wireless networks, personal networks (PAN), and the like. Network 103 is for illustration purposes and may be replaced with fewer or additional computer networks. A local area network (LAN) may have one or more of any known LAN topologies and may use one or more of a variety of different protocols, such as Ethernet. Devices 101, 105, 107, 109 and other devices (not shown) may be connected to one or more of the networks via twisted pair wires, coaxial cable, fiber optics, radio waves or other communication media.

Computing device 101 may comprise a processor 111, RAM 113, ROM 115, network interface 117, input/output interfaces 119 (e.g., keyboard, mouse, display, printer, etc.), and memory 121. Processor 111 may comprise one or more computer processing units (CPUs), graphical processing units (GPUs), and/or other processing units such as a processor adapted to perform computations associated with database queries, interactions with client applications, scheduling and tracking of scan requests associated with a system of interest, generating remediation actions associated with a completed scan, logging scan results, logging remediation actions and risk levels in a database, and other functions. I/O 119 may comprise a variety of interface units and drives for reading, writing, displaying, and/or printing data or files. I/O 119 may be coupled with a display such as display 120. Memory 121 may store software for configuring computing device 101 into a special purpose computing device in order to perform one or more of the various functions discussed herein. Memory 121 may store operating system software 123 for controlling overall operation of computing device 101, control logic 125 for instructing computing device 101 to perform aspects discussed herein. Furthermore, memory 121 may store various databases and applications depending on the particular use, for example, user database 127, bank account database 129, credit card database 131, and/or other applications 133 may be stored in a memory of a computing device used at a server system that will be described further below. Control logic 125 may be incorporated in and/or may comprise a linking engine that updates, receives, and/or associates various information stored in the memory 121 (e.g., authentication information, risk management information, and remediation information, etc.). In other embodiments, computing device 101 may include two or more of any and/or all of these components (e.g., two or more processors, two or more memories, etc.) and/or other components and/or subsystems not illustrated here.

Devices 105, 107, 109 may have similar or different architecture as described with respect to computing device 101. Those of skill in the art will appreciate that the functionality of computing device 101 (or device 105, 107, 109) as described herein may be spread across multiple data processing devices, for example, to distribute processing load across multiple computers, to segregate transactions based on geographic location, user access level, quality of service (QoS), etc. For example, devices 101, 105, 107, 109, and others may operate in concert to provide parallel computing features in support of the operation of control logic 125 and/or user database 127.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

Having discussed several examples of computing devices which may be used to implement some aspects as discussed further below, discussion will now turn to an illustrative environment and network for predictive modeling based on pattern recognition.

The predictive modeling system may comprise multiple components working together to analyze transaction records and account balances to identify patterns and predict future behavior relating to purchases and the ability to pay for those purchases in a timely manner. Such a system may reduce losses by financial institutions and benefit consumers by reducing high interest debt.

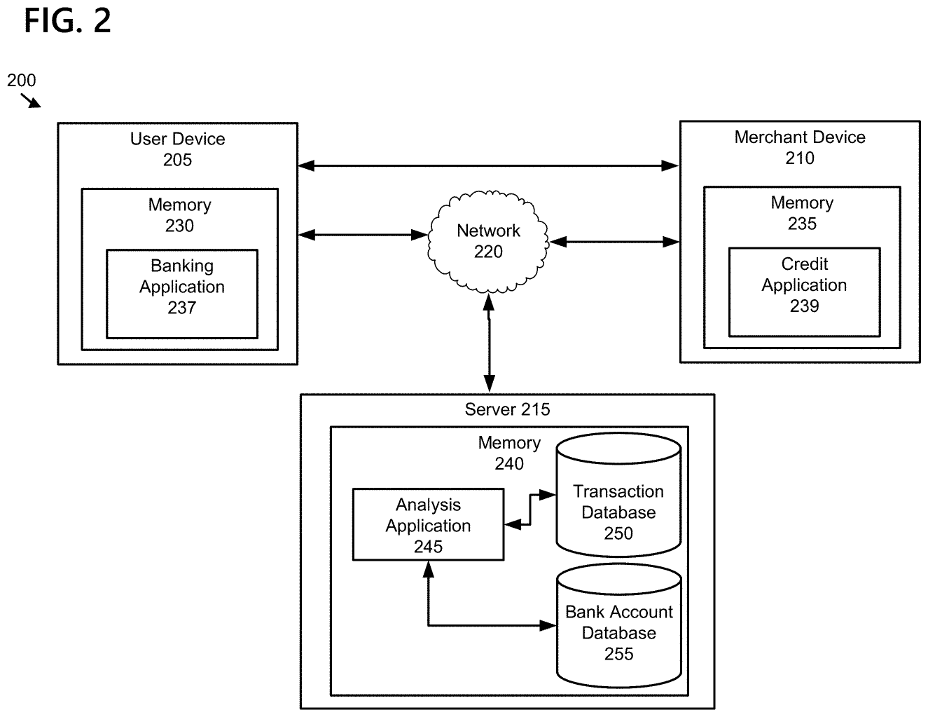

As noted above, a predictive model (e.g., machine learning model) may be used to predict whether a purchase (e.g., a credit purchase) will be repaid on time. FIG. 2 shows an example system 200 for training a predictive model to detect activity patterns of an account associated with a user. System 200 may comprise a user device 205, a merchant device 210, and a server 215 interconnected via a network 220.

User device 205 may be any one of the devices described above with respect to FIG. 1. Additionally or alternatively, the user device 205 may be a transaction card (e.g., credit card) and/or a mobile device with the ability to purchase goods and/or services on credit, for example, by accessing a user's credit card information (e.g., Apple Pay, Samsung Pay, Google Pay, etc.). User device 205 may comprise a processor (not shown) and/or a memory 230. The processor may comprise a single central processing unit (CPU), which may be a single-core or multi-core processor, or may comprise multiple CPUs. The processor may allow the user device 205 to execute a series of computer-readable instructions (e.g., instructions stored in memory 230) to perform some or all of the processes described herein. In some examples, the processor may be smart chip or an integrated circuit that comprises a microprocessor and memory, such as read only memory (ROM) and random access memory (RAM). The smart chip may comprise one or more contact pads to receive voltage to power user device 205 and exchange signals with a terminal, such as merchant device 210. The smart chip may be configured to execute one or more applications, such as processing payments, verifying a cardholder, confirming a transaction, etc. The memory 230 may comprise one or more physical persistent memory devices and/or one or more non-persistent memory devices. Memory 230 may include, but is not limited to, random access memory (RAM), read only memory (ROM), electronically erasable programmable read only memory (EEPROM), flash memory or other memory technology, optical disk storage, magnetic cassettes, magnetic tape, magnetic disk storage or other magnetic storage devices, or any other medium that may be used to store the desired information and that may be accessed by the processor. Memory 230 may store one or more applications, such as a banking application 237. A user may, via banking application 237 executing on the user device 205, initiate a credit card purchase from a merchant, either directly at a merchant location or through the network 220. The merchant may use credit card information supplied by the user device 205 to process the transaction.

Merchant device 210 may receive the credit card information supplied by the user device 205 to process the transaction. Merchant device may comprise a processor (not shown) and memory 235. The processor may be similar to the processors discussed above with respect to user device 205. Similarly, memory 235 may be one or more of the types of memory discussed above with respect to memory 230. In some examples, merchant device 210 may comprise a point-of-sale (PoS) terminal, EMV reader, or an equivalent thereof. Additionally or alternatively, merchant device 210 may comprise a computing device configured to process online transactions. Credit application 239 may, for example, process payments, authenticate (e.g., verify) a cardholder, confirm a transaction, etc. on behalf of the merchant. A record of the transaction (e.g., credit card purchase) may be sent (e.g., transmitted) to server 215.

Server 215 may be any suitable computing device configured to process and/or record the transaction. In this regard, server 215 may be a transaction server. The transaction server may be associated with a financial institution, a creditor, credit card processing entity, or any combination thereof. Server 215 may be any suitable server, such as server system 130 described above with respect to FIG. 1. In this regard, server 215 may comprise databases similar to user database 127, bank account database 129, and/or credit card database 131, or any combination thereof. Server 215 may comprise a processor (not shown) and a memory 240. The processor may be similar to the processors discussed above with respect to user device 205. Memory 240 may be one or more of the types of memory discussed above with respect to memory 230. In this regard, memory 240 may comprise one or more databases, including, for example, a transaction database 250, a bank account database 255. Additionally or alternatively, memory 240 may store one or more applications, such as an analysis application 245. The analysis application 245 may comprise a predictive model. The predictive model may be based on machine learning algorithms. The machine learning model may be trained to determine whether a purchase (e.g., a credit purchase) will be repaid on time. Additionally or alternatively, the machine learning model may be trained to authenticate user transactions (e.g., deposits and withdrawals), for example, to better detect fraudulent transactions. The machine learning model may be a neural network, such as a generative adversarial network (GAN) or a consistent adversarial network (CAN), such as a cyclic generative adversarial network (C-GAN), a deep convolutional GAN (DC-GAN), GAN interpolation (GAN-INT), GAN conditional latent space (GAN-CLS), a cyclic-CAN (e.g., C-CAN), or any equivalent thereof. The neural network may be trained using supervised learning, unsupervised learning, back propagation, transfer learning, stochastic gradient descent, learning rate decay, dropout, max pooling, batch normalization, long short-term memory, skip-gram, or any equivalent deep learning technique. The machine learning model may be trained on the data and/or information stored in the transaction database 250 and/or the bank account database 255. In this regard, the machine learning model may be trained on a plurality of users' bank account activity, history of credit purchases to define a pattern of credit purchases, a pattern of the user's bank account balances, etc. The machine learning model may determine whether a purchase (e.g., a credit card purchase) will be repaid on time, for example, based on at least one of: a transaction history of the user, a bank account balances of the user, a monthly income of the user, or any other suitable factor. In this regard, the machine learning model may monitor a user's bank account activity, history of credit purchases to define a pattern of credit purchases, a pattern of the user's bank account balances, etc. to determine whether the user will repay the transaction. Additionally, the machine learning model may monitor the user's bank account activity, history of credit purchases to define a pattern of credit purchases, a pattern of the user's bank account balances, etc. to detect fraudulent transactions. By monitoring the user's cash flow and detecting possible fraudulent transactions, the machine learning model described herein may improve banking security by monitoring the user's bank account to detect irregularities in cash flow and/or transactions.

As part of its analysis to determine whether the user initialized the transaction and whether the user will be able to repay the transaction when due, the analysis application 245 may identify whether a user has recurring deposits, such as from social security or from an employer. The analysis application 245 may also identify any recurring charges, for example, monthly vehicle payments, mortgage payments, mobile phone payments, groceries, etc. In some examples, the analysis application 245 may identify an average daily spend of the user. The average daily spend may be defined as the average amount a user spends, for example, as identified by withdrawals from their bank account and/or charges incurred on one or more credit cards. In further examples, the analysis application 245 may also factor for seasonal expenditures, non-recurring incoming funds, and/or non-recurring outgoing funds. These expenditures may comprise, for example, a tax payment (e.g., home, automobile, income, etc.), an annual vacation, holiday shopping, birthday shopping, etc.

By monitoring the bank account levels, transaction history, incoming and outgoing expenses, and/or credit card activity of the user, the analysis application 245 may train the predictive model (e.g., machine learning model) to better forecast the user's spending habits, including the incoming funds and/or outgoing expenses associated with a user's bank account. The analysis application 245 may be able to predict the balance of the user's bank account when payment for a credit transaction will be due, for example, based on the analysis application 245 monitoring credit transactions through the transaction database 250. Monitoring transaction database 250 may also help the predictive model (e.g., machine learning model) to identify fraudulent transactions. For example, if a customer usually spends less than $40 per transaction, an alert may be generated on a purchase of greater than $300. The alert may flag the purchase as a fraudulent transaction. Additionally or alternatively, the alert may trigger a user verification of the transaction. In this regard, a financial institution (e.g., a bank, a creditor, a credit card issuer, etc.) may contact the consumer to verify the transaction. If the consumer verifies the transaction, the alert may be cleared. However, if the consumer indicates that they did not authorize the transaction, the credit card purchase may be flagged as a fraudulent purchase and corrective action may be taken.

Based on the analysis of the bank account levels, transaction history, incoming and outgoing expenses, and/or credit card activity of the user, the analysis application 245 may determine that the user will not have enough money to pay off a bill (e.g., credit card bill) when it is due. This may be due, in part, to the user's normal spending habits. Additionally or alternatively, the determination that the user will not have enough money to cover their bill may be due, in part, to an outlier purchase. An outlier purchase may be a purchase that is greater than the user's typical purchase by a predetermined amount. Additionally or alternatively, the analysis application 245 may determine that purchases may prevent the user from making any additional purchases with the credit card. That is, the analysis application 245 may determine that the user is approaching and/or has reached their spending limit associated with the credit card.

Based on a determination that the user may not be able to cover their bill, the analysis application 245 may take proactive action. For example, analysis application 245 may offer the user the ability to refinance one or more credit card purchases. Additionally or alternatively, analysis application 245 may search for refinancing options and present the refinancing options to the user. The refinancing options may be determined, for example, using a scraping algorithm. Additionally or alternatively, the analysis application 245 may offer to temporarily increase the user's credit limit. The increase may be equal to an amount of the one or more recent credit card purchases. In some examples, the increase may be temporary and/or time limited, for example, for a single billing cycle. In further examples, analysis application 245 may underwrite the account for a personal loan and/or an alternative or promotional financing offer. In still further examples, refinancing may comprise contacting the merchant from whom the user made the credit card purchase to explore the availability of a payment plan and/or alternative financing between the merchant and the user.

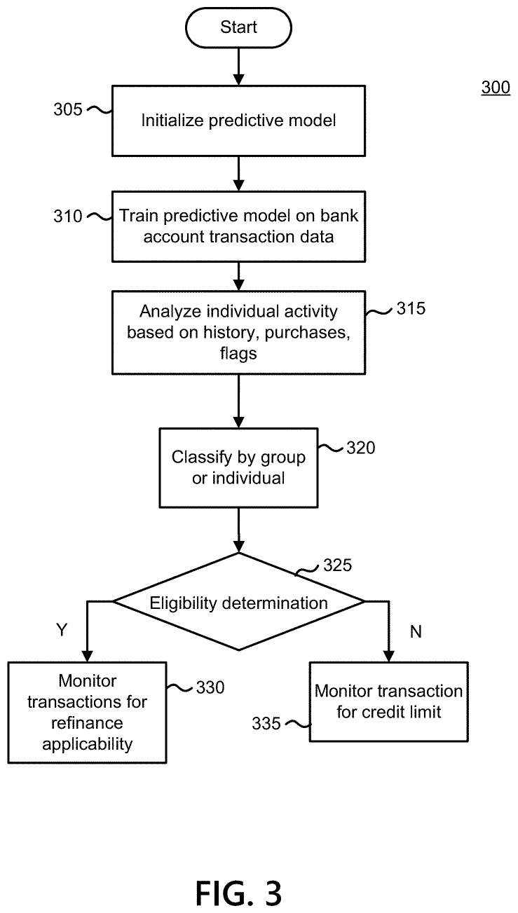

As noted above, a predictive model (e.g., machine learning model) may analyze a user's financial records to determine the user's ability to repay and/or provide refinancing options. FIG. 3 shows an example of a process 300 for analyzing a user's financial records using a predictive model (e.g., machine learning model) according to one or more aspects of the disclosure. Some or all of the steps of process 300 may be performed using one or more computing devices as described herein.

In step 305, a device may initialize a predictive model (e.g., machine learning model). Initializing the predictive model (e.g., machine learning model) may comprise selecting one or more predictive models from a plurality of predictive models, including, for example, GAN, CAN, C-GAN, DC-GAN, GAN-INT, GAN-CLS, C-CAN, or any equivalent thereof. Initializing the predictive model (e.g., machine learning model) may also comprise selecting one or more inputs for the predictive model and/or assigning weights to each of the one or more inputs. The one or more inputs may comprise transaction data and/or historical datasets associated with a particular user. The historical datasets may comprise a pattern of the user's purchases and/or account balances over a particular period of time. Additionally or alternatively, the one or more inputs may comprise identifying one or more users or groups of users that have similar spending habits, account balances, income, etc. After the one or more users or groups of users have been identified, transaction data and/or historical datasets of the one or more users or groups of users may be chosen as an input for the predictive model. By relying on other users' historical data as an input, the predictive model (e.g., machine learning model) may be better suited to predict a user's ability to pay and/or mitigate uncertainties regarding the user's future ability to pay.

In step 310, the predictive model (e.g., the machine learning algorithm) may be trained on the one or more inputs selected above. The predictive model (e.g., machine learning algorithm) may be trained using supervised learning, unsupervised learning, back propagation, transfer learning, stochastic gradient descent, learning rate decay, dropout, max pooling, batch normalization, long short-term memory, skip-gram, or any equivalent deep learning technique. Accordingly, each of the one or more inputs selected above may be used to train the predictive model using one or more of the techniques described above. In this regard, the predictive model may be trained to recognize amounts of transactions (e.g., deposits, withdrawals, transfers, etc.), dates associated with transactions, payee information, account information (e.g., for funds and/or entities that receive or deposit funds), etc.

In step 315, the predictive model (e.g., machine learning model) may be used to analyze individual activity. For example, once the predictive model (e.g., machine learning model) is trained, the predictive model may be used to analyze individual user activity to determine whether the user is at-risk of falling short with respect to their payments. The predictive model (e.g., machine learning model) may analyze a user's historical transaction data. The historical transaction data may comprise financial activity associated with the bank account, such as transactional data. The transactional data may comprise at least one of: deposits, withdrawals, monthly payments, investments, purchases, returns, and/or any other activity indicators. The analysis may provide insight into the user's cashflow, spending habits, budgetary habits, etc. Additionally or alternatively, the analysis may reveal flags and/or warnings about the user, such as an overdrawn account and/or any other indications of insufficient funds.

Based on the analysis, the device may classify the user in step 320. For example, the account and/or its associated user may be classified as being part of an identified group. The identified group may indicate whether the user is financially sound or whether the user is at-risk of being overdrawn. In some examples, the account and/or its user may be classified in one or more groups. In further examples, the account and/or its user may be deemed unclassified, for example, if there is insufficient data with respect to the user and/or the account. Unclassified accounts and/or users may be re-analyzed periodically. Additionally or alternatively, unclassified accounts and/or users may be identified as individuals, and not grouped in with other users and/or accounts.

In step 325, the device may determine whether the user and/or group is eligible for one or more refinancing offers. The determination of whether the user and/or group is eligible for one or more refinancing offers may be based on the user, group, and/or account classification. For example, if the predictive model (e.g., machine learning model) determines that a particular user has a poor track record of making timely payments for their credit card purchases, the user may be eligible for refinancing. Similarly, if the user has a low credit score, is delinquent in their payments, or is not paying off their credit card account in a timely fashion, a determination may be made that the user is eligible for refinancing. In step 330, the user's credit card purchases may be monitored to determine whether one or more purchases and/or transactions are eligible for refinancing. If one or more purchases and/or transactions are eligible for refinancing, the device may determine one or more refinancing options and present the user with the one or more refinancing options. However, if the user is not eligible for one or more refinancing options, the device may monitor the user's purchases and/or transactions in step 335. Additionally or alternatively, the device (e.g., the predictive model) may monitor the account to identify when that user is approaching or exceeding their spending limit.

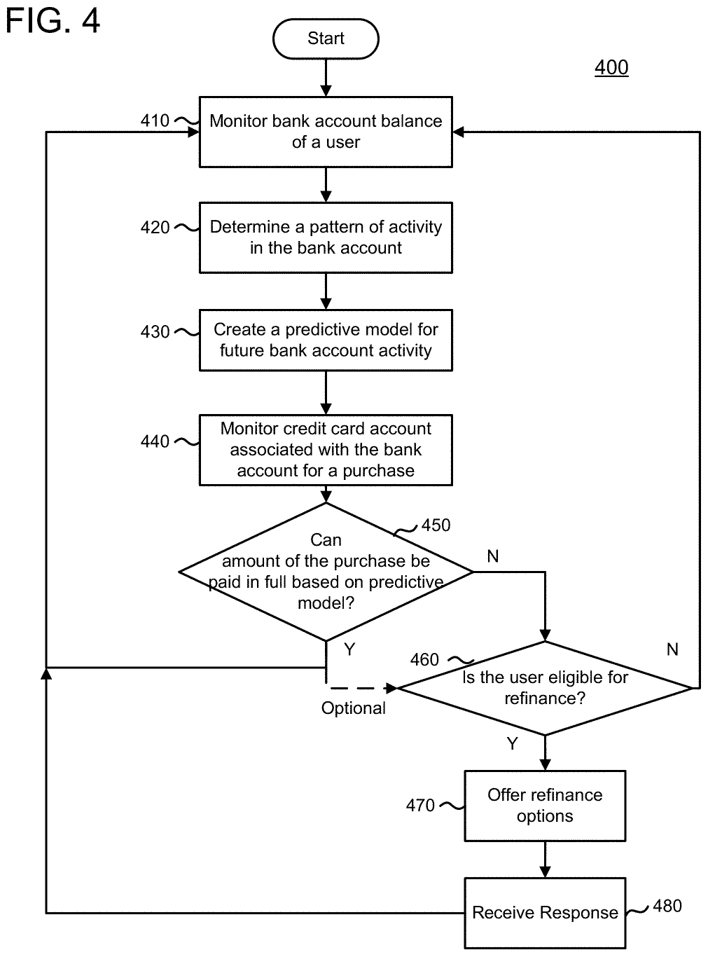

Once a user has been identified as being eligible for refinancing offers, the server may monitor one or more accounts associated with the identified user to determine purchases that may be eligible for refinancing options. FIG. 4 shows an example of a process 400 for monitoring one or more bank accounts to determine whether one or more purchases are eligible for refinancing. Some or all of the steps of process 400 may be performed using one or more computing devices as described herein.

In step 410, a device may monitor one or more account balances associated with one or more accounts. The one or more accounts may belong to a single user or a plurality of users. The user, or each of the plurality of users, may have a plurality of bank accounts with one or more institutions. The device may monitor the plurality of bank accounts to determine the user's assets (e.g., total liquid assets). In some examples, the device may monitor one or more accounts at a one or more financial institutions. In this regard, the user may provide authentication information (e.g., username and password, account number, etc.) to add one or more accounts associated with different financial institutions to the monitoring service. It will be appreciated that the user' assets (e.g., balances) may fluctuate (e.g., day-to-day) based on a plurality of factors, including, for example, deposits, withdrawals, interest payments, dividends, etc.

In step 420, the device may determine (e.g., identify) a pattern of activity associated with the one or more accounts. Determining the pattern of activity may comprise identifying recurring deposits, such as bi-weekly paychecks, monthly or quarterly interest payments, dividend payments, social security payments, etc. Some recurring deposits (e.g., paychecks, social security payment, etc.) may comprise regular amounts. Additionally or alternatively, determining the pattern of activity may comprise identifying recurring liabilities (e.g., withdrawals), including, for example, monthly mortgage payments, utility payments, cellular data plans, credit card payments, etc. In some examples, the device may determine a percentage of withdrawals as a percentage of total income. For example, the device may determine that monthly withdrawals do not exceed ten percent (10%) of the account's monthly deposits. By identifying recurring deposits and liabilities, the device may determine a user's cashflow, for example, based on an overall pattern of deposits and withdrawals. The device may identify a user's current cashflow. Additionally, the device may be able to more accurately predict a user's cashflow based on the detected pattern and/or the machine learning model trained above.

In step 430, the device may create a predictive model, for example, based on the determined pattern of activity. The predictive model created based on one or more of the machine learning models described above. The predictive model may determine a projected cashflow, for example, based on recurring deposits (e.g., paychecks, social security payments, etc.) and liabilities (e.g., mortgage payments, utilities, cellular data plan, credit card payments, etc.). By using the predictive model, the device may determine a periodic (e.g., daily, weekly, monthly, etc.) account balance and/or cashflow associated with the one or more accounts.

In step 440, the device may monitor one or more credit cards associated with the user. Monitoring the one or more credit cards may be performed as part of monitoring the one or more bank accounts. In some examples, the one or more bank accounts and the credit card may be managed by the same financial institution. As part of the monitoring, the device may identify deposits and/or liabilities that do not fit with the pattern of activity associated with the account. For example, the device may identify a bonus that has been deposited in one or more of the user's accounts. Similarly, the device may identify a purchase that may be higher than a typical credit purchase. In this regard, the device, or the user, may define a threshold amount for purchases. That is, a purchase over a certain amount or a certain percentage may be flagged by the device. Alternatively, the device may determine whether a purchase surpasses the user's daily spending by a significant amount (e.g., ≥5×). In these instances, the device may flag (e.g., identify) these purchases for further analysis.

In step 450, the device may determine whether the purchase will be paid in full when the next credit card payment is due. Additionally or alternatively, the device may determine whether the user will be able to make the increased minimum payment at the next payment due date. In this regard, the device may use the predictive model (e.g., machine learning model) to determine whether the user will be able to remit payment for the purchase. Determining whether the user will be able to remit payment may comprise predicting whether the user will have sufficient funds in their bank account when payment will be due. The determination in step 450 may be performed only for credit card purchases identified in step 440 that exceed the user's normal daily spend by a predetermined amount. Additionally or alternatively, the determination may be made for one or more, or all, of the credit card purchases identified in step 450. If the predictive model predicts that the amount of a credit card purchase will be paid in full when due, then the method reverts back to step 410 to continue monitoring the bank account balance of the user.

If the predictive model (e.g., machine learning model) determines that the amount of a credit card purchase will not be paid in full when due, the device may determine whether the purchase is eligible for refinancing in step 460. Determining whether the purchase is eligible for refinancing may comprise determining whether one or more refinancing options exist for the purchase. In some instances, the device may determine the purchase's eligibility for refinancing. If the purchase is not eligible for refinancing, process 400 may return to step 410 where the device may continue monitoring the one or more bank accounts balances is continued. The model may determine that the user is able to pay their credit card statement, but may not have an available credit limit to make additional purchases. In this caser, the device may determine that the user is eligible for one or more refinancing options to allow the user to make additional purchases. Additionally or alternatively, the device may send (e.g., transmit) an offer to increase the user's credit limit.

If a determination is made that the purchase is eligible for refinancing, then the device may cause one or more refinancing options to be presented (e.g., displayed) to the user in step 470. The device may send (e.g., transmit) the refinancing options to a mobile communication device associated with the user. The refinancing options may be sent (e.g., transmitted) to the user through a mobile application, at the time the user logins into their account via a website, via an electronic communication (e.g., text message, email, etc.), or an equivalent thereof. The user may be presented with refinancing options as early as the day on which a credit card charge is posted to their account, or at a later time, but prior to the date the credit card purchase amount would be due. As noted above, refinancing options may comprise raising the credit limit of the user, for example, raising the limit in the amount of the credit card purchase. Additionally or alternatively, the user may be given the option to negotiate with the merchant to finance (refinance) the purchase directly. In some examples, the device may scrape a plurality of websites, using a scraping algorithm, to determine the one or more refinancing options. The one or more refinancing options may allow the user to refinance some or all of their credit card debt, improve their credit rating, and/or increase their cash flow. In response to sending the refinancing options, the device may receive a response from the user device in step 480. The response may comprise a denial of the offer to refinance. Alternatively, the response may comprise an acceptance of one or more of the refinance options. Accordingly, the device may refinance the purchase amount. In some examples, the purchase amount may be credited to the credit card account.

The above-described systems, devices, and methods may provide for a predictive model (e.g., machine learning model) that may determine a pattern of activity associated with a user account. Based on the pattern of activity, the predictive model (e.g., machine learning model) may be better able to forecast whether a user will be able to pay their bills in a timely manner and, when the user cannot, offer the user refinancing options to assist with the user's cashflow. Additionally, the predictive model (e.g., machine learning model) may provide improved fraud detection services. By monitoring the user's cash flow and detecting possible fraudulent transactions, the machine learning model described herein may improve banking security associated with user accounts.

One or more features discussed herein may be embodied in computer-usable or readable data and/or computer-executable instructions, such as in one or more program modules, executed by one or more computers or other devices as described herein. Program modules may comprise routines, programs, objects, components, data structures, and the like. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid-state memory, RAM, and the like. The functionality of the program modules may be combined or distributed as desired. In addition, the functionality may be embodied in whole or in part in firmware or hardware equivalents such as integrated circuits, field programmable gate arrays (FPGA), and the like. Particular data structures may be used to more effectively implement one or more features discussed herein, and such data structures are contemplated within the scope of computer executable instructions and computer-usable data described herein. Various features described herein may be embodied as a method, a computing device, a system, and/or a computer program product.

Although the present disclosure has been described in terms of various examples, many additional modifications and variations would be apparent to those skilled in the art. In particular, any of the various processes described above may be performed in alternative sequences and/or in parallel (on different computing devices) in order to achieve similar results in a manner that is more appropriate to the requirements of a specific application. It is therefore to be understood that the present disclosure may be practiced otherwise than specifically described without departing from the scope and spirit of the present disclosure. Although examples are described above, features and/or steps of those examples may be combined, divided, omitted, rearranged, revised, and/or augmented in any desired manner. Thus, the present disclosure should be considered in all respects as illustrative and not restrictive. Accordingly, the scope of the disclosure should be determined not by the examples, but by the appended claims and their equivalents.

1. A computer-implemented method comprising:
monitoring, by a transaction server, a bank account associated with a user;
training a predictive model, based on the monitoring and through a plurality of iterations, to predict an account balance associated with the bank account, wherein training the predictive model is based on at least one of: recurring deposits, recurring withdrawals, transactional data, or historical data associated with the account;
authenticating, by the transaction server, an identity of the user in conjunction with a credit card purchase;
posting, by the transaction server, a purchase amount associated with the credit card purchase to a credit card account associated with the user, wherein the credit card account and bank account are administered under control of the transaction server;
determining, using the predictive model, that the purchase amount will not be paid in full when due; and
generating, based on the determining and prior to when a payment for the credit card purchase is due, an option to the user to refinance the purchase amount.

2. The computer-implemented method of claim 1, further comprising:
receiving, from the user, an indication of an acceptance of the option to refinance the purchase amount;
underwriting the bank account for a loan; and
paying the purchase amount to the credit card account.

3. The computer-implemented method of claim 1, further comprising:
sending, by the transaction server, the option to refinance to a mobile device associated with the user.

4. The computer-implemented method of claim 1, wherein the monitoring comprises detecting recurring deposits and recurring charges.

5. The computer-implemented method of claim 1, wherein the predictive model comprises adjusts for at least one of seasonality and non-recurring activity in the bank account.

6. The computer-implemented method of claim 1, wherein the predictive model is trained to determine an average daily spend associated with the bank account.

7. The computer-implemented method of claim 6, further comprising:
determining that the purchase amount exceeds the average daily spend by a threshold amount; and
generating, based on the determining that the purchase amount exceeds the average daily spend by a threshold amount, an alert.

8. The computer-implemented method of claim 1, wherein the predictive model comprises at least one of: a generative adversarial network (GAN), a consistent adversarial network (CAN), a cyclic generative adversarial network (C-GAN), a deep convolutional GAN (DC-GAN), GAN interpolation (GAN-INT), GAN conditional latent space (GAN-CLS), or a cyclic-CAN (C-CAN).

9. The computer-implemented method of claim 1, wherein the generating the option occurs after the purchase amount is posted to the credit card account.

10. The computer-implemented method of claim 1, further comprising:
receiving, from the user, an indication of an acceptance of the option to refinance the purchase amount; and
increasing a credit limit associated with the credit card account, wherein the credit limit increase is temporary.

11. The computer-implemented method of claim 10, wherein the credit limit increase is equivalent to the purchase amount.

12. The computer-implemented method of claim 10, wherein the credit limit increase is limited to one billing cycle.

13. An apparatus comprising:
one or more processors; and
memory storing instructions that, when executed by the one or more processors, cause the apparatus to:
monitor a bank account associated with a user;
train a predictive model, based on the monitoring and through a plurality of iterations, to predict an account balance associated with the bank account, wherein training the predictive model is based on at least one of: recurring deposits, recurring withdrawals, transactional data, or historical data associated with the account;
authenticate an identity of the user in conjunction with a credit card purchase;
post a purchase amount associated with the credit card purchase to a credit card account associated with the user, wherein the credit card account and bank account are administered under control of the apparatus;
determine, based on the predictive model, that the purchase amount will not be paid in full when due; and
generate, based on the prediction and prior to when a payment for the credit card purchase is due, an option to the user to refinance the purchase amount.

14. The apparatus of claim 13, wherein the instructions, when executed by the one or more processors, further cause the apparatus to:
receive, from the user, an indication of an acceptance of the option to refinance the purchase amount;
underwrite the bank account for a loan; and
pay the purchase amount to the credit card account.

15. The apparatus of claim 13, wherein the instructions, when executed by the one or more processors, further cause the apparatus to:
send the option to refinance to a mobile device associated with the user.

16. The apparatus of claim 13, wherein the predictive model is trained to determine an average daily spend associated with the bank account.

17. The apparatus of claim 16, wherein the instructions, when executed by the one or more processors, further cause the apparatus to:
determine that the purchase amount exceeds the average daily spend by a threshold amount; and
generate, based on determining that the purchase amount exceeds the average daily spend by a threshold amount, an alert.

18. The apparatus of claim 17, wherein the predictive model comprises at least one of: a generative adversarial network (GAN), a consistent adversarial network (CAN), a cyclic generative adversarial network (C-GAN), a deep convolutional GAN (DC-GAN), GAN interpolation (GAN-INT), GAN conditional latent space (GAN-CLS), or a cyclic-CAN (C-CAN).

19. A non-transitory computer readable medium storing instructions that, when executed by one or more processors, cause a computing device to perform steps comprising:
monitoring a bank account associated with a user;
training a predictive model, based on the monitoring and through a plurality of iterations, to predict an account balance associated with the bank account, wherein training the predictive model is based on at least one of: recurring deposits, recurring withdrawals, transactional data, or historical data associated with the account;
authenticating an identity of the user in conjunction with a credit card purchase;
posting a purchase amount associated with the credit card purchase to a credit card account associated with the user, wherein the credit card account and bank account are administered under control of the transaction server;
determining, based on the predictive model, that the purchase amount will not be paid for in full when due;
generating, based on the predicting and prior to when a payment for the credit card purchase is due;
sending the option to refinance to a device associated with the user; and
receiving, from the device, an indication of an acceptance of the option to refinance.

20. The non-transitory computer readable medium of claim 19, wherein training the predictive model comprises at least one of: supervised learning, unsupervised learning, back propagation, transfer learning, stochastic gradient descent, learning rate decay, dropout, max pooling, batch normalization, long short-term memory, skip-gram, or deep learning.

21. The computer-implemented method of claim 1, further comprising:
monitoring, by a transaction server, a second bank account associated with the user, wherein the second bank account is not administered under control of the transaction server.
